(19) United States
(12) Patent Application Publication
(10) Pub. No.: US 2022/0104514 A1
(43) Pub. Date: Apr. 7, 2022

(54) SHELF STABLE HIGH PROTEIN POWDER COMPOSITION AND METHOD OF MAKING A FROZEN OR CHILLED HIGH PROTEIN CONFECTION

(71) Applicant: ProSynthesis Laboratories, Inc., Sterling, VA (US)

(72) Inventors: Jerome G. KRACHENFELS, Reston, VA (US); Aaron MACHA, La Crosse, WI (US)

(73) Assignee: ProSynthesis Laboratories, Inc., Sterling, VA (US)

(21) Appl. No.: 17/493,333

(22) Filed: Oct. 4, 2021

Related U.S. Application Data
(60) Provisional application No. 63/087,678, filed on Oct. 5, 2020.
(60) Provisional application No. 63/134,360, filed on Jan. 6, 2021.

(51) Int. Cl. A23G 9/38; A23G 9/34; A23G 9/32; A23G 9/04

(52) U.S. Cl. CPC A23G 9/38; A23G 9/34; A23G 9/04; A23G 9/325; A23G 9/327

(57) ABSTRACT

The present invention relates to a high protein shelf stable powder composition comprising form about 52 to 80% of a protein source having a lipid content, from about 5-18% of a protein encapsulated fat, from about 5-18% of a mineral source that is whey permeate, lactose, sweet whey powder or a dairy mineral blend or a mixture thereof and from about 0.2% to 5.0% stabilizing agent or a mixture of stabilizing agents. The composition may also contain flavorings, salts, starch, sweetener and/or soluble fiber. The amounts are by weight of the composition. The invention also relates to preparing a high protein frozen confection from the shelf stable powder composition.

### SUMMARY

The present invention relates to a shelf stable high protein powder composition and a method for preparing a high protein composition. The shelf stable powder can readily be made at home into a high protein ice-cream-like, soft serve or pudding confection simply by mixing the powder with certain liquids and chilling or freezing. The resulting confection is very high in protein, very low in sugar and low in fat.

Another aspect of the present invention is a soft serve frozen confection prepared from the shelf stable powder.

Moreover, the shelf stable powder can be stored at room temperature and when mixed with liquid and chilled, the resulting mixture has a smooth pleasing taste and pudding like texture. When mixed with liquid and frozen the resulting mixture has a smooth pleasing taste with a creamy ice cream like texture which is notably not icy. The shelf-stable powder is easily mixable with water (or other liquid) by the consumer. No equipment such as pasteurization, homogenization, mechanical mixing or “industrial” refrigeration is needed to produce the very high protein content, very low fat and low or no sugar confection.

The invention is not limited to confections. In certain embodiments, depending on the flavorings and spices added, the shelf stable high protein composition may also be formulated into a savory mixture.

Thus, the present invention relates to a shelf stable high protein powder composition and a method for preparing a high protein frozen or chilled confection or a high protein savory mixture. The powder composition comprises a protein source having a lipid content or a protein source and an added lipid source. Preferably, the composition contains from 52 to 80% by weight of a protein source having a lipid content. Alternatively, the composition contains from 40% to 70% by weight of a protein source and added lipids so that the total lipid content of the composition ranges from 4% to 20%, depending on the level of other emulsifiers, sweeteners, and stabilizers. It is known that some consumers prefer lower levels of fat, and the associated lower levels of fat, and it is a valuable accomplishment of the invention that it achieves an appealing texture and taste without the level of fat found in most ice creams. Fat levels between 4% and 15% are preferred. Most preferred are fat levels between 6-13%. Particularly preferred are fat levels between 7-11%.

The sources of the lipids include both the primary protein source, which sometimes contains residual lipids, as well as independently added lipids, as described herein.

The composition also contains 4-18% of a protein encapsulated fat, 5-18% of a mineral source that is whey permeate, lactose, sweet whey powder or a dairy mineral blend or a mixture thereof and 0.2% to 5.0% of a stabilizing agent or a mixture of stabilizing agents. The composition may optionally further comprise flavoring agents, calcium salts, chloride salts, starch sweetener and soluble fiber. Unless otherwise stated, the amounts disclosed herein are by weight of the composition.

The present invention also relates to a method of preparing a high protein confection from the claimed composition. The high protein confection may be frozen to create an ice-cream like confection or refrigerated to create a pudding like confection.

Upon further study of the specification and appended claims, further objects and advantages of this invention will become apparent to those skilled in the art.

### DETAILED DESCRIPTION OF THE INVENTION

The present invention relates to a high protein shelf stable powder composition comprising form about 52 to 80% of a protein source having a lipid content, from about 5-18% of a protein encapsulated fat, from about 5-18% of a mineral source that is whey permeate, lactose, sweet whey powder or a dairy mineral blend or a mixture thereof and from about 0.2% to 5.0% stabilizing agent or a mixture of stabilizing agents. The composition may also contain up to 2.5% flavorings, up to 5% calcium salts, up to 0-4% chloride salts, up to 0-4% starch, up to 0-15% sweetener and up to 0-3% soluble fiber. The amounts are by weight of the composition.

Preferably, the protein source comprises lipids between 0.2%-4% by weight of the protein source. Also preferred are compositions containing 7-15% of a protein encapsulated fat, 7-15% of a mineral source (e.g., whey permeate), 0.5-4% of a calcium salt (e.g., calcium carbonate), 0.25-3% of a chloride salt and 0.5% to 3.0% of a stabilizing agent or a mixture thereof (e.g. gelatin, agar, Xanthan, acacia, guar).

Preferred sweeteners include allulose sucralose, saccharin, acesulfame, aspartame, neotame, stevia riboside, erythritol, a sugar alcohol or fructose. Particularly preferred are compositions containing from 5.0% to 11.0% of a sugar alcohol and compositions containing from 05 to 3% of a soluble fiber (e.g., psyllium husk, cellulose, resistant starch, lignin, digestion-resistant maltodextrin or chitin).

The invention also relates to methods for preparing a high protein frozen confection comprising adding the shelf stable high protein powder to a liquid, mixing (e.g., by stirring, blending or shaking) and freezing.

The invention also relates to methods for preparing a high protein frozen soft serve confection comprising adding the shelf stable high protein powder and water or liquid of choice into a conventional soft serve hopper and mechanically agitating while freezing. Optionally, air can be incorporated while mixing.

The invention also relates to methods for preparing a high protein pudding confection comprising adding the shelf stable high protein powder to a liquid, mixing (e.g., by stirring, blending or shaking) and chilling.

In certain embodiments where the primary high protein source does not contain lipids or contains low amounts of lipids, lipid sources may be added to the composition. Thus, another preferred embodiment of the present invention relates to a high protein shelf stable powder composition comprising from about 52 to 75% of a protein source (e.g., pea Protein, rice protein or mixtures thereof), from about 5-18% of a protein encapsulated fat, from about 5-18% of a mineral source (e.g., whey permeate, lactose, sweet whey powder or a dairy mineral blend or a mixture thereof), from about 0.2% to 5.0% of a stabilizing agent (or mixture thereof) and from about 0.2% to 15% of a lipid source. The composition may also contain up to 2.5% flavorings, up to 5% calcium salts, up to 0-4% chloride salts, up to 0-4% starch, up to 0-15% sweetener and up to 0-3% soluble fiber. The amounts are by weight of the composition.

Preferred primary protein sources include a protein source having a lipid content such as, for example, ProCreme™ or a whey protein isolate (WPI) combined with similar levels of lipid to provide similar total protein and similar total lipids. Also preferred are Milk protein concentrates (MPC) such as, for example, SureProtein™, IdaPro MPC 80 LL™ or IdaPlus 1085™. Other suitable commercial MPC sources are, for example, MILK SPECIALTIES, VITUSA DAIRY and FONTERRA. Also preferred are plant proteins such as, for example, pea protein combined with similar levels of lipid to provide similar total protein and similar total lipids. Whey protein concentrate and whey protein isolate are commercially available milk derivatives made by either filtration of whey from cheese making or direct filtration of milk, or ion-exchange process to concentrate/isolate protein components in whey from cheese making. Pea protein and other plant proteins are often made using extraction and filtration to concentrate the protein.

Most commercial whey protein concentrates, contain between 35 and 82% protein with varying amounts of residual lipids. Mixtures of various protein sources having various amounts of lipids may also be used. Triacylglycerol's are the major lipid class, followed by phospholipids, diacylglycerols, FFA, cholesterol esters, cholesterol, and monoacylglycerol. For example, Procream™ is a co-product obtained during manufacture of whey protein isolate. It mainly contains whey proteins (63%-72%), fat (12-20%), and approximately 18-20% of phospholipids (PLs) in total fat. Protein sources of the present invention may contain up to 21% phospholipids by weight of the protein source. Preferably, the protein source contains a lipids content of between 0.2%-4% by weight of the protein. Most preferably the protein source contains a lipids content of between 0.4%-4 by weight of the protein. Other suitable commercially available primary whey protein sources are, for example, BiPRO™ available from AGROPUR INGREDIENTS; Provon™, Thermax™ or HarvestPro™ available from GLANBIA NUTRITIONALS, INC. Also suitable are Whey protein concentrate 80 available from LEPRINO FOODS; Hilmar™ 9400 WPI; Hilmar™ 8011 WPC, Hilmar™ 8200 WPC, Hilmar™ 8350 WPC, 8370 WPC, 8500 WPC, 8610 WPC, 8800 WPC, 9410 WPI, available from HILMAR INGREDIENTS. Commercially available primary protein sources are also available from for example FONTERRA, VOCAL, TINE, ARLA, and CARDBERRY. Optipep® from CARBERY; Grande™, WPC's KwikMix™ and Zerlac™ available from MILK SPECIALTIES are also suitable. WPC concentrate 80 available from SAPUTO, WPI available from MULLINS, WPC's or WPI's available from SACHEENMILC, WPC 80, WPI 90 or ProCream™ available from BONGARDS are also suitable.

Supplemental lipids may be added to compositions of the present invention where the protein source does not contain lipids or does not contain high enough amounts of lipids, such as, for example, pea protein. In some case, separately-added lipids could range from 0.2% to 15% of the composition weight. Preferred supplemental lipids are Phospholipids such as lecithin and phosphatidylcholine with a range of 0.2-2%. Without being bound to any particular theory, it is believed that the hydrophobic interactions in the fatty acid tails help minimize reactions in water during freezing. Lipids also act, in part, as an emulsifiers. While phospholipids are preferred, other suitable lipids include, for example, Fatty acids, Glycerolipids, Glycerophospholipids, Spingolipid, Saccharolipids, Polyketides, Sterol lipids, Penol lipids or mixtures thereof.

Whey protein phospholipid concentrate (WPPC) may be used as a supplemental phospholipid source. WPPC is composed primarily of whey proteins and dairy lipids from the milk fat globule membrane. Suitable commercial phospholipid sources include, for example, Isochill 6000™ from AGROPUR INGREDIENTS, Perham P_{c}-Protein™ from BONGARDS CREAMERIES, Whey Phospholipid Protein Concentrate from MILK SPECIALTIES GLOBAL and Whey Protein Concentrate High Fat from LEPRINO FOODS (Denver, Colo.).

The protein encapsulated fats act, in part, as an emulsifiers. They also smooth the texture and the mouthfeel as well as reducing hardness of product when frozen and especially during the thawing process—while concurrently maintaining a soft-solid texture. There is a wide range of suitable encapsulated fat powders available in the food industry. Creamers are among the most commonly used, along with dietary supplements. U.S. Pat. Nos. 7,374,788, 4,670,285, 7,141,265, disclose suitable protein encapsulated fats and methods of making and using the same. In general, encapsulated fat powders, including high fat dairy powders, exhibit a superior shelf life by reducing oxidation. Preferred protein encapsulated fat sources include, for example, LACTALIS, DIEHL, CREAMER, AGROPUR, VITAL BLEND™, ACH, ADM. Preferably, the composition includes from 9-18% of a protein encapsulated fat, by weight of the composition. Most preferably, the composition includes from 10-14% of a protein encapsulated fat, by weight of the composition.

Preferred mineral sources include, for example, whey permeate, lactose, sweet whey powder or a dairy mineral blend or a mixture thereof. The mineral source acts, in part, to depress the freezing point, i.e. the temperature at which the product freezes solid. Whey permeate is a commercially available milk derivative made by filtration of whey from cheese making. Numerous suitable whey permeates are available from, for example, BONGARDS, GLANBIA, AGROPUR, LEPRINO, HILMAR, FONTERRA, VOCAL, TINE, ARLA, CARDBERRY, GRANDE, MILK SPECIALTIES, SAPUTO, MULLINS, SACHFENMILCH. Preferably, the claimed composition contains between about 5-18% of a mineral source or a blend. Most preferably the composition contains from about 7% to 15% of the formula by weight of a mineral source or a blend of mineral sources.

Preferably, the claimed composition contains between about 0.2% to 5.0% by weight of a stabilizing agent or a mixture of stabilizing agents. Most preferably, the claimed composition contains between about 0.5% to 3.0% by weight of a stabilizing agent or a mixture of stabilizing agents. In addition to preventing ice crystals from forming in the frozen form of the claimed invention, stabilizing agents also function to viscosify, as thickening agents and as texture enhancers. Preferred stabilizing agent include, for example, Xanthan gum, Gum Arabic, Guar Gum, Agar, carrageen, gelatin, pectin, cellulose, cellulose derivatives, locust bean gum and alginate. Most preferred stabilizers include Xanthan gum, Gum Arabic and Guar Gum.

Xanthan gum is a preferred stabilizing agent. It is created by a sugar that's fermented by a bacteria. It is a soluble fiber and commonly used to thicken or stabilize foods, improve the texture, consistency, flavor, shelf life and appearance of many foods. In addition to stabilizing foods, Xanthan gum helps certain foods withstand different temperatures and pH levels. Sources of Xanthan gum include TIC GUMS, COYOTE, JBL, CP KELCO and CARGILL.

Another Preferred stabilizing agent is Gum Arabic, also known as gum sudani, acacia gum, arabic gum, gum acacia, acacia, Senegal gum and Indian gum, and by numerous other names. It is a natural gum consisting of the hardened sap of two species of the acacia (Sensu lato) tree, the Acacia Senegal (now known as Senegalia Senegal) and Vachellia (Acacia) seyal. Sources of Gum Arabic include TIC GUMS, COYOTE, JBL, CP KELCO and CARGILL.

Another preferred stabilizing agent is Guar gum, also called guaran, which comes from the seed of a bean-like (legume) plant, sometimes referred to as the Indian tree. Sources of Guar Gum include TIC GUMS, COYOTE, JBL, CP KELCO and CARGILL.

The composition may contain up to 15% sweeteners. A skilled worker would recognize that the amount and weight of sweetener would depend on the type of sweetener. For example, Inulin is not very sweet so a larger amount by weight would be required. In certain embodiments of the present invention, Inulin, a pre-biotic fiber, is preferred. Thus, in such compositions, the amount of sweetener by weight would be higher than compositions that contain an artificial sweetener. The relative sweetness of sweeteners can be measured by comparing the threshold values for various types of sugar and sugar substitutes. Sucrose, or table sugar, is the taste that most artificial sweeteners try to mimic. Sucralose is about 600 times sweeter than sugar and thus on a weight basis much less sucralose would be required to obtain the same level of perceived sweetness as table sugar. Equal™, which is a brand of artificial sweetener containing aspartame, acesulfame potassium, dextrose and maltodextrin, is 200 times sweeter than table sugar. Low glycemic index sweeteners are preferred. Preferred sweeteners include, for example, saccharin, acesulfame, aspartame, neotame, stevia ribosides, any natural or artificial high intensity sweetener, yacon, Xylitol, tagatose, sorbitol, saccharin, Oligofructose, mannitol, maltitol, monk fruit, lactitol, isomalt, inulin, glycerol, cyclamate and/or advantame.

High glycemic index sweeteners may also be used in moderation, such as, for example, barley malt syrup, molasses, brown rice syrup, cane sugar, cane juice, palm sugar, dextrose, glactose, glucose, golden syrup, high fructose corn syrup, honey, lactose, maltodextrin, maltose, maple syrup, sorghum syrup and trehalose.

A most preferred sweetener is Allulose/Erythritol. To make allulose, manufacturer starts with corn, breaks it down into starch and fructose and then converts the fructose to allulose via an enzymatic conversion process using enzymes from a genetically engineered microbe. The enzymes—which serve as processing aids—are not in the final product. Also preferred are other sugar alcohols, fructose and other sugars in smaller amounts due to customer preferences for lower sugars and lower calories. In a preferred embodiment the composition contains from 5.0% to 11.0% by weight of allulose.

The present invention allows for a wide range of flavor sources, including natural and artificial flavors. The amount of flavoring agent within the composition will of course vary depending on the flavoring agent. A preferred flavoring agent is Cocoa, which is commercially available from, for example, BLOMMER, ADM, OLAM or CIRANDA.

The composition may also contain up to 5% by weight calcium salts. Commonly used calcium salts and their respective calcium content include, for example, Calcium acetate: 250 mg (12.5 mEq) per gram. Calcium carbonate: 400 mg (20 mEq) per gram. Calcium chloride: 270 mg (13.5 mEq) per gram. Calcium citrate: 210 mg (10.5 mEq) per gram. A most preferred calcium salt is Calcium carbonate which is a white, odorless powder or colorless crystals. It has a role in the food industry as an antacid, a food coloring agent or a food firming agent

The composition may also contain up to 4% by weight chloride salts. Chloride salts include sodium chloride, potassium chloride, calcium chloride and ammonium chloride. A suitable food grade potassium Chloride is available from CARGILL. A suitable food grade sodium Chloride is available from CARGILL or UNITED SALT.

As a sodium alternative, the composition may also contain up to 2% by weight Tetrasodium pyrophosphate.

The composition may also contain up to 4% by weight starch. Starches act, in part, as viscosity modifying agents, bulking agent, moisture binding and to add texture and mouth feel. They also act to adjust or stabilize pH. Suitable starches derived from maize, waxy maize, high amylose maize, wheat, tapioca and potato; native starches are generally used for the purpose of food texturizing and thickening. Pre-gelatinized starches are starches that develop viscosity without the need for heat. Specialty starches offer a range of functional properties such as texturizing, binding, thickening, gelling and stabilizing. Suitable commercially available starches such as, for example, Gel-Instant™, Cargill Gel™, AmyloGel™ native high amylose starch, Cream Gel™ native tapioca starch are available from CARGILL.

The claimed composition may contain up to 3% of a soluble fiber. The soluble fiber acts, in part, as a bulking agent and also helps depress freezing point. Preferred soluble fibers include, for example, psyllium husk, cellulose, resistant starches, lignin or chitins. A most preferred soluble fiber is FIBERSOL available from ADM OR MATSUTANI. Preferably the composition contains from 0.05% to 3% soluble fiber.

Method of Use

The shelf stable powder is mixed with a beverage of choice by the consumer. One preferred method is to measure out the recommended volume of liquid, then add the recommended powder, and stir with a utensil such as a spoon until the mixture is reasonably smooth. Another preferred method is to combine the recommended amounts in a shaker and shake vigorously. Another preferred method is to combine the recommended amounts in a blender and blend.

The resultant mixture, in a desired container, is put into a freezer. The preferred range for freezing is minus −10 degrees Fahrenheit up to plus 20 degrees Fahrenheit, but any freezing temperature is also preferred. Freezing time will vary according to temperature and the amount of air flow in the freezer. Two to four hours are not uncommon freezing times. The prepared product can be enjoyed either fully frozen, partially frozen or chilled.

Water is preferred mixing liquid, as are the primary variations in cow's milk (e.g., 1% fat, 2% fat, and whole milk, which contains about 3.25% fat). Plant-based alternatives to milk, such as almond milk, other nut milks, oat milk, and soy milk are also preferred.

Depending on the amount of water/liquid added in proportion to the powder, the frozen mixture will have ice crystals ranging in size from 10 μm to over 50 μm in diameter, with an average size 20 um to 40 um, again depending of the proportions of water to the powder. A preferred proportion for freezing is 110 grams of water and 50 grams of powder. Another preferred proportion is 100 grams of water and 50 grams of powder. A third preferred proportion is 120 grams of water and 50 grams of powder. The result is a mouth feel that tasters in our taste panels describe as smooth or creamy. For making chilled pudding, about 10% less water/liquid is preferred.

The shelf stable powder can also be used to prepare a soft serve type frozen confection. The shelf stable powder is mixed with water or liquid of choice in a conventional soft serve type refrigeration and dispensing machine such as, for example, those disclosed in U.S. Pat. No. 6,622,511B2; US20190166874A1; U.S. Pat. Nos. 7,681,761B2; 6,490,872B1; 6,494,055B1; 6,553,779B1; US20180103656A1; U.S. Pat. No. 6,651,448B2; EP3434112A1; US20180153188A1; U.S. Pat. Nos. 9,693,571B2; 5,016,446A; 6,662,592B2; 6,988,372B2; 7,266,952B2; 10,463,059B2; 10,834,940B2; 9,980,504B2; 9,326,531B1 or U.S. Pat. No. 10,035,115B2. Depending on the desired soft serve consistency, the soft serve mixture preferably contains from 20-40% of the claimed shelf stable powder and from 60-80% liquid of choice. The soft serve of the present invention has a texture similar to traditional soft serve ice creams but a little denser. It has many small frozen particles, but they are not crystallized together to create a solid. The particles move freely, creating a cold yet creamy thick “fluid” texture.

Traditional soft serve is generally produced at a temperature of about −4° C. (25° F.). Soft serve contains air, introduced at the time of freezing. The air content, called overrun, can vary from 0 to 60 percent of the total volume of finished product. The amount of air alters the taste of the finished product. Low quantities of air result in a soft serve with a heavy, icy taste. Soft serve with higher air content tastes creamier, smoother, and lighter and appears whiter. The optimum quantity of air is determined by other ingredients, if any, and individual taste. Preferably the air content is between 30 and 50 percent of volume. Most preferably the air content is between 33 and 45 percent of volume.

The shelf stable powder can also be used to provide a single serving of a soft serve type frozen confection using a pod comprising the claimed shelf stable powder. Systems for providing a. single serving of a frozen confection can be found, for example, in U.S. Pat. No. 10,358,284B2.

The shelf stable powder and liquid can be added separately or as a mixture to soft serve type equipment directly into the hopper or to a mixing cavity. Optional flavored concentrates may also be added. In a preferred embodiment, the shelf stable powder and liquid mixture is mechanically agitated at a temperature of preferably between about 10-30° F. (−12° to −1° C.) for mixing times of 20 minutes plus, depending on temperature, to deliver the desired consistency and time for dispensing. A temperature in the range of about 20° to 30° F. (−16 to −1° C.) is particularly preferred. The incorporation of air through mixing blades can also be used to increase the smoothness and the texture of the soft serve. The agitation of the mixing can be consistent or sporadic through life of the mixture. The texture can range from soft and running to relative stiff and hard.

The shelf stable powder can also be used to provide a single serving of a soft serve type frozen confection using a pod comprising the claimed shelf stable powder. Systems for providing a single serving of a frozen confection can be found, for example, in U.S. Pat. No. 10,358,284B2.

To increase the protein content and enhance the flavor of pancakes and/or waffles the shelf stable powder can also be added to waffle and/or pancake mix. Preferably, the shelf stable powder can also be added to waffle and/or pancake mix along with an egg.

The shelf stable powder can also be used to make baked products such as, for example, muffins waffles and pancakes. This accomplished by mixing with water; with water and an egg; or with water, egg and a baking type mixture and then baking or heating and a hot surface such as, for example, a waffle or pancake baker or an oven.

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding U.S. Provisional Application Ser. No. 63/087,678, filed Oct. 5, 2020 and 63/134,360 filed Jan. 6, 2021, are incorporated by reference herein.

### EXAMPLES

The present invention is illustrated by the following non-limiting examples:

### Example 1

READY TO FREEZE OR CHILL SHELF
STABLE POWDERED COMPOSITION

| | % BY WEIGHT OF |
|---|---|
| INGREDIENT | COMPOSITION |
| Protein source with phospholipid | 76.80% |
| content | |
| protein encapsulated fat | 5.00% |
| Whey Permeate | 5.00% |
| Salt | 0.10% |
| Erythritol | 0.90% |
| resistant starch | 4.00% |
| Calcium Carbonate | 1.00% |
| Stabilizer | 0.20% |
| Allulose | 2.00% |
| Sucralose | 3.00% |
| Flavors | 2.00% |
| | 100.00% |

### Example 2

READY TO FREEZE OR CHILL SHELF
STABLE POWDERED COMPOSITION

| | % BY WEIGHT OF |
|---|---|
| INGREDIENT | COMPOSITION |
| Whey Protein Isolate | 76.80% |
| protein encapsulated fat | 6.00% |
| Whey Permeate | 5.00% |
| Salt | 0.10% |
| Erythritol | 0.90% |
| Lecithin | 1.00% |
| Calcium Carbonate | 2.00% |
| Stabilizer | 0.20% |
| Allulose | 2.00% |
| Sucralose | 3.00% |
| Flavors | 3.00% |
| | 100.00% |

### Example 3

READY TO FREEZE OR CHILL SHELF
STABLE POWDERED COMPOSITION

| | % BY WEIGHT OF |
|---|---|
| INGREDIENT | COMPOSITION |
| Milk Protein Concentrate 70 | 63.8% |
| protein encapsulated fat | 7.70% |
| Whey Permeate | 7.00% |
| Salt | 0.10% |
| Lecithin | 1.00% |
| resistant starch | 4.00% |
| Calcium Carbonate | 1.00% |
| Stabilizer | 5.20% |
| Allulose | 5.20% |
| Sucralose | 3.00% |
| Flavors | 2.00% |
| | 100.00% |

### Example 4

READY TO FREEZE OR CHILL SHELF
STABLE POWDERED COMPOSITION

| | % BY WEIGHT OF |
|---|---|
| INGREDIENT | COMPOSITION |
| Whey Protein Concentrate 80 | 78.80% |
| protein encapsulated fat | 3.00% |
| Whey Permeate | 5.00% |
| Diglycerides | 0.10% |
| Erythritol | 0.90% |
| resistant starch | 4.00% |
| Calcium Carbonate | 1.00% |
| Stabilizer | 0.20% |
| Allulose | 2.00% |
| Acesulfame Potassium | 3.00% |
| Flavors | 2.00% |
| | 100.00% |

### Example 5

READY TO FREEZE OR CHILL SHELF
STABLE POWDERED COMPOSITION

| | % BY WEIGHT OF |
|---|---|
| INGREDIENT | COMPOSITION |
| Protein source with phospholipid | 77.70% |
| content | |
| protein encapsulated fat | 5.00% |
| Whey Permeate | 5.00% |
| Salt | 0.10% |
| Maltitol | 1.00% |
| resistant starch | 4.00% |
| Calcium Carbonate | 1.00% |
| Stabilizer | 0.20% |
| Allulose | 2.00% |
| Sucralose | 3.00% |
| Flavors | 1.00% |
| | 100.00% |

### Example 6

READY TO FREEZE OR CHILL SHELF
STABLE POWDERED COMPOSITION

| | % BY WEIGHT OF |
|---|---|
| INGREDIENT | COMPOSITION |
| Pea Protein Isolate | 78.80% |
| protein encapsulated fat | 5.00% |
| Whey Permeate | 5.00% |
| Salt | 0.10% |
| Erythritol | 0.90% |
| resistant starch | 4.00% |
| Phosphatidylcholine | 1.00% |
| Stabilizer | 0.20% |
| Allulose | 2.00% |
| Sucralose | 1.00% |
| Flavors | 2.00% |
| | 100.00% |

### Example 7

READY TO FREEZE OR CHILL SHELF
STABLE POWDERED COMPOSITION

| | % BY WEIGHT OF |
|---|---|
| INGREDIENT | COMPOSITION |
| Protein source with phospholipid | 76.80% |
| content | |
| protein encapsulated fat | 5.00% |
| Whey Permeate | 5.00% |
| Salt | 0.10% |
| Erythritol | 0.90% |
| resistant starch | 4.00% |
| Calcium Carbonate | 1.00% |
| Stabilizer | 0.20% |
| Mannitol | 4.00% |
| Stevia | 1.00% |
| Flavors | 2.00% |
| | 100.00% |

### Example 8

READY TO FREEZE OR CHILL SHELF
STABLE POWDERED COMPOSITION

| | % BY WEIGHT OF |
|---|---|
| INGREDIENT | COMPOSITION |
| Protein source with phospholipid | 76.00% |
| content | |
| protein encapsulated fat | 5.00% |
| Whey Permeate | 5.00% |
| Salt | 0.10% |
| Erythritol | 0.90% |
| resistant starch | 4.00% |
| Calcium Carbonate | 1.00% |
| Tic Ultra Smooth Gums | 1.00% |
| Allulose | 2.00% |
| Sucralose | 3.00% |
| Flavors | 2.00% |
| | 100.00% |

### Example 9

READY TO FREEZE OR CHILL SHELF
STABLE POWDERED COMPOSITION

| | % BY WEIGHT OF |
|---|---|
| INGREDIENT | COMPOSITION |
| Whey Protein Isolate | 70.80% |
| protein encapsulated fat | 5.70% |
| Whey Permeate | 7.00% |
| Salt | 0.10% |
| Lecithin | 2.00% |
| resistant starch | 6.20% |
| Calcium Carbonate | 1.00% |
| Stabilizer | 0.20% |
| Allulose | 1.00% |
| Sucralose | 3.00% |
| Flavors | 3.00% |
| | 100.00% |

### Example 10

READY TO FREEZE OR CHILL SHELF
STABLE POWDERED COMPOSITION

| | % BY WEIGHT OF |
|---|---|
| INGREDIENT | COMPOSITION |
| Protein source with phospholipid | 76.80% |
| content | |
| Non Dairy Creamer 50% Fat | 7.00% |
| Whey Permeate | 3.00% |
| Salt | 0.10% |
| Erythritol | 0.90% |
| resistant starch | 4.00% |
| Calcium Carbonate | 1.00% |
| Stabilizer | 0.20% |
| Allulose | 2.00% |
| Sucralose | 3.00% |
| Flavors | 2.00% |
| | 100.00% |

### Example 11

READY TO FREEZE OR CHILL SHELF
STABLE POWDERED COMPOSITION

| | % BY WEIGHT OF |
|---|---|
| INGREDIENT | COMPOSITION |
| Rice Protein Concentrate 80 | 76.80% |
| Monoglyceride | 5.00% |
| Whey Permeate | 4.10% |
| Salt | 1.00% |
| Erythritol | 0.90% |
| resistant starch | 4.00% |
| Calcium Carbonate | 1.00% |
| Stabilizer | 0.20% |
| Allulose | 2.00% |
| Aspartame | 3.00% |
| Flavors | 2.00% |
| | 100.00% |

### Example 12

READY TO FREEZE OR CHILL SHELF
STABLE POWDERED COMPOSITION

| | % BY WEIGHT OF |
|---|---|
| INGREDIENT | COMPOSITION |
| Protein source with phospholipid | 76.80% |
| content | |
| protein encapsulated fat | 5.50% |
| Whey Permeate | 5.00% |
| Salt | 0.10% |
| Erythritol | 2.90% |
| resistant starch | 4.00% |
| Calcium Carbonate | 1.00% |
| Stabilizer | 0.20% |
| Allulose | 2.00% |
| Stevia | 0.50% |
| Flavors | 2.00% |
| | 100.00% |

### Example 13

READY TO FREEZE OR CHILL SHELF
STABLE POWDERED COMPOSITION

| | % BY WEIGHT OF |
|---|---|
| INGREDIENT | COMPOSITION |
| Protein source with phospholipid | 60.80% |
| content | |
| protein encapsulated fat | 11.00% |
| Whey Permeate | 5.00% |
| Salt | 2.60% |
| Erythritol | 2.40% |
| Resistant starch | 6.00% |
| Calcium Carbonate | 2.00% |
| Stabilizer | 1.20% |
| Allulose | 3.00% |
| Sucralose | 3.00% |
| Flavors | 3.00% |
| | 100.00% |

### Example 14

READY TO FREEZE OR CHILL SHELF
STABLE POWDERED COMPOSITION

| | % BY WEIGHT OF |
|---|---|
| INGREDIENT | COMPOSITION |
| Protein source with phospholipid | 71.80% |
| content | |
| protein encapsulated fat | 5.00% |
| Whey Permeate | 5.00% |
| Salt | 0.10% |
| Erythritol | 0.90% |
| resistant starch | 7.00% |
| Calcium Carbonate | 1.00% |
| Stabilizer | 0.20% |
| Allulose | 2.00% |
| Sucralose | 5.00% |
| Flavors | 2.00% |
| | 100.00% |

READY TO FREEZE OR CHILL SHELF
STABLE POWDERED COMPOSITION

| | % BY WEIGHT OF |
|---|---|
| INGREDIENT | COMPOSITION |
| Protein source with phospholipid | 62.1% |
| content | |
| protein encapsulated fat | 7.70% |
| Whey Permeate | 7.00% |
| Salt | 0.10% |
| Erythritol | 0.90% |
| resistant starch | 4.00% |
| Calcium Carbonate | 1.00% |
| Stabilizer | 5.20% |
| Allulose | 7.00% |
| Sucralose | 3.00% |
| Flavors | 2.00% |
| | 100.00% |

### Example 15

READY TO FREEZE OR CHILL SHELF
STABLE POWDERED COMPOSITION

| | % BY WEIGHT OF |
|---|---|
| INGREDIENT | COMPOSITION |
| Protein source with phospholipid | 76.80% |
| content | |
| protein encapsulated fat | 5.00% |
| Whey Permeate | 5.00% |
| Salt | 0.10% |
| Erythritol | 0.90% |
| resistant starch | 4.00% |
| Calcium Carbonate | 1.00% |
| Stabilizer | 0.20% |
| Allulose | 2.00% |
| Sucralose | 3.00% |
| Flavors | 2.00% |
| | 100.00% |

### Example 16

READY TO FREEZE OR CHILL SHELF
STABLE POWDERED COMPOSITION

| | % BY WEIGHT OF |
|---|---|
| INGREDIENT | COMPOSITION |
| Pea Protein Concentrate | 73.80% |
| protein encapsulated fat | 5.00% |
| Whey Permeate | 5.00% |
| Salt | 0.10% |
| Erythritol | 0.90% |
| Lecithin | 4.00% |
| Calcium Carbonate | 1.00% |
| Stabilizer | 0.20% |
| Xylitol | 5.00% |
| Stevia | 3.00% |
| Flavors | 2.00% |
| | 100.00% |

### Example 17

READY TO FREEZE OR CHILL SHELF
STABLE POWDERED COMPOSITION

| | % BY WEIGHT OF |
|---|---|
| INGREDIENT | COMPOSITION |
| Whey Protein Isolate | 76.80% |
| protein encapsulated fat | 5.00% |
| Whey Permeate | 5.00% |
| Salt | 0.10% |
| Erythritol | 0.90% |
| resistant starch | 4.00% |
| Calcium Carbonate | 1.00% |
| Stabilizer | 0.20% |
| Allulose | 4.00% |
| Stevia Reb A | 1.00% |
| Lecithin | 2.00% |
| | 100.00% |

### Example 18

READY TO FREEZE OR CHILLSHELF
STABLE POWDERED COMPOSITION

| | % BY WEIGHT OF |
|---|---|
| INGREDIENT | COMPOSITION |
| Protein source with phospholipid | 56.80% |
| content | |
| protein encapsulated fat | 10.00% |
| Whey Permeate | 10.00% |
| Salt | 0.10% |
| Erythritol | 0.90% |
| resistant starch | 4.00% |
| Calcium Carbonate | 1.00% |
| Stabilizer | 5.20% |
| Allulose | 7.00% |
| Sucralose | 3.00% |
| Flavors | 2.00% |
| | 100.00% |

### Example 19

READY TO FREEZE OR CHILL SHELF
STABLE POWDERED COMPOSITION

| | % BY WEIGHT OF |
|---|---|
| INGREDIENT | COMPOSITION |
| Whey Protein Concentrate 80 | 73.80% |
| Non Dairy Creamer 20% Fat | 8.00% |
| Whey Permeate | 5.00% |
| Salt | 0.10% |
| Erythritol | 1.90% |
| resistant starch | 4.00% |
| Calcium Carbonate | 1.00% |
| Stabilizer | 0.20% |
| Allulose | 3.80% |
| Monk Fruit | 0.20% |
| Flavors | 2.00% |
| | 100.00% |

### Example 20

READY TO FREEZE OR CHILL SHELF
STABLE POWDERED COMPOSITION

| | % BY WEIGHT OF |
|---|---|
| INGREDIENT | COMPOSITION |
| Milk Protein Isolate | 72.80% |
| protein encapsulated fat | 7.00% |
| Whey Permeate | 5.00% |
| Salt | 0.10% |
| Erythritol | 0.90% |
| Lecithin | 4.00% |
| Calcium Carbonate | 1.00% |
| Stabilizer | 2.20% |
| Allulose | 2.00% |
| Sucralose | 3.00% |
| Flavors | 2.00% |
| | 100.00% |

### Example 21

READY TO FREEZE OR CHILL SHELF
STABLE POWDERED COMPOSITION

| | % BY WEIGHT OF |
|---|---|
| INGREDIENT | COMPOSITION |
| Sodium Caseinate | 75.80% |
| protein encapsulated fat | 5.00% |
| Whey Permeate | 5.00% |
| Salt | 0.10% |
| Erythritol | 0.90% |
| resistant starch | 4.00% |
| Triglycerides | 3.00% |
| Stabilizer | 0.20% |
| Allulose | 2.00% |
| Sucralose | 2.00% |
| Flavors | 2.00% |
| | 100.00% |

### Example 21

READY TO FREEZE OR CHILL SHELF
STABLE POWDERED COMPOSITION

| | % BY WEIGHT OF |
|---|---|
| INGREDIENT | COMPOSITION |
| Protein source with phospholipid | 62.80% |
| content | |
| protein encapsulated fat | 7.00% |
| Whey Permeate | 7.00% |
| Salt | 2.10% |
| Erythritol | 3.90% |
| Resistant starch | 1.00% |
| Calcium Carbonate | 5.00% |
| Stabilizer | 5.20% |
| Allulose | 1.00% |
| Sucralose | 3.00% |
| Flavors | 2.00% |
| | 100.00% |

### Example 22

READY TO FREEZE OR CHILL SHELF
STABLE POWDERED COMPOSITION

| | % BY WEIGHT OF |
|---|---|
| INGREDIENT | COMPOSITION |
| Milk Protein Concentrate/Whey Protein | 66.80% |
| Concentrate | |
| Non Dairy Creamer 50% Fat | 15.45% |
| Milk Permeate Powder | 5.00% |
| Soy lecithin | 0.10% |
| Erythritol | 4.90% |
| Resistant Starch | .30% |
| Calcium Carbonate | 1.00% |
| Stabilizer | 0.20% |
| Allulose | 2.00% |
| Soluble fiber | 0.25% |
| Flavors | 4.00% |
| | 100.00% |

### Example 23

CUSTOMER-PREPARED PROPORTIONS OF READY
TO CONSUME FINISHED FROZEN PRODUCT

| | % BY WEIGHT OF |
|---|---|
| | READY TO CONSUME |
| INGREDIENT | FINISHED PRODUCT |
| Powder described herein | 33.3% |
| Water | 66.7% |
| | 100.00% |

### Example 24

CUSTOMER-PREPARED PROPORTIONS OF READY TO
CONSUME FINISHED CHILLED PUDDING PRODUCT

| | % BY WEIGHT OF |
|---|---|
| | READY TO CONSUME |
| INGREDIENT | FINISHED PRODUCT |
| Powder described herein | 40.0% |
| Water | 60.0% |
| | 100.00% |

### Example 25

1.834 ounces of the Shelf Stable powder according to Example 1 and 3.5 ounces of water are added to the Cuisinart™ 1.5 Quart Frozen Yogurt ICE-21P1 Ice Cream Maker. The freezer bowl is frozen overnight prior to use. The machine is run for 20 minutes while the powder and water mix. The resulting mixture has a creamy thick, fairly high viscosity yet “fluid”, soft serve texture when dispensed.

### Example 25

1.834 ounces of the Shelf Stable powder according to Example 1 and 3.5 ounces of water are added to the TAYLOR 794 3 Phase Soft Serve Machine. The TAYLOR 794 is preset for a temperature of 30 degrees Fahrenheit. The machine run time is for 20 minutes while the powder and water mix. The resulting mixture has a creamy, fairly high viscosity yet “fluid”, soft serve texture when dispensed.

### Example 27

3.1 ounces of the Shelf Stable powder according to Example 13 and 6 ounces of water are added to the LELLO 4080 Musso Lussino Ice Cream Maker. The machine is run for 30 minutes while the powder and water mix, and the bowl cools to the chill and churn setting. The resulting mixture has a creamy, fairly high viscosity yet “fluid”, soft serve texture when dispensed.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

We claim:

1) A high protein shelf stable powder composition comprising:
a) 52 to 80% of a protein source having a lipid content,
b) 5-18% of a protein encapsulated fat,
c) 5-18% of a mineral source that is whey permeate, lactose, sweet whey powder or a dairy mineral blend or a mixture thereof,
d) 0.2% to 5.0% stabilizing agent or a mixture of stabilizing agents
e) 0-2.5% flavoring,
f) 0-5% calcium salts,
g) 0-4% chloride salts or sodium salts
h) 0-4% starch
i) 0-15% sweetener and
j) 0-3% soluble fiber,
wherein said amounts are by weight of the composition.

2) The composition of claim 1, wherein said lipid content comprises between 0.2%-4% by weight of the protein source.

3) The composition of claim 1, comprising 7-15% of a protein encapsulated fat.

4) The composition of claim 1, comprising 7-15% of a mineral source.

5) The composition of claim 4, wherein said mineral source is whey permeate.

6) The composition of claim 1, comprising 0.5-4% calcium salts.

7) The composition of claim 6, wherein said calcium salt is calcium carbonate.

8) The composition of claim 1, comprising 0.25-3% chloride salts.

9) The composition of claim 1, comprising 0.5% to 3.0% stabilizing agent.

10) The composition of claim 9, wherein said stabilizing agent is gelatin, agar, Xanthan, acacia, guar or a mixture thereof.

11) The composition of claim 1, wherein said composition comprises between about 6-10% lipids by weight of the composition.

12) The composition of claim 1, wherein said sweetener is allulose, sucralose, saccharin, acesulfame, aspartame, neotame, stevia riboside, erythritol, a sugar alcohol or fructose.

13) The composition of claim 1, wherein said sweetener includes from 5.0% to 11.0% of a sugar alcohol.

14) The composition of claim 1, comprising 0.05 to 3% of a soluble fiber.

15) The composition of claim 1, wherein said starch is from 0.5% to 4.0% of Maltodextrin.

16) The composition of claim 14, wherein said soluble fiber is psyllium husk, cellulose, resistant starch, lignin, digestion-resistant maltodextrin or chitin.

17) A method for preparing a high protein frozen confection comprising:
adding a liquid to the composition of claim 1, and freezing.

18) A method for preparing a high protein pudding confection comprising:
adding a liquid to the composition of claim 1 and stirring, mixing or shaking.

19) A high protein shelf stable powder composition comprising:
a) 52 to 75% of a protein source
b) 5-18% of a protein encapsulated fat,
c) 5-18% of a mineral source that is whey permeate, lactose, sweet whey powder or a dairy mineral blend or a mixture thereof,
d) 0.2% to 5.0% stabilizing agent
e) 0.2% to 20% of a lipid source
f) 0-2.5% flavoring,
g) 0-5% calcium salts,
h) 0-4% chloride salts or sodium salts
i) 0-4% if a starch
j) 0% to 15% sweetener and
k) 0-3% soluble fiber,
amounts by weight of the composition.

20) The composition of claim 19, wherein said protein source is pea Protein, rice protein or mixtures thereof and said lipid is lecithin or phosphatidylcholine.

21) A method of preparing a soft-serve type frozen confection comprising
mixing the composition of claim 1 with a liquid
freezing while agitating
and
introducing air at the time of freezing to a final air content between 30 and 50 percent of volume of said soft-serve type frozen confection.

22) A method of preparing a soft-serve type frozen confection comprising
mixing the composition of claim 19 with a liquid
freezing while agitating
and
introducing air at the time of freezing to a final air content between 30 and 50 percent of volume of said soft-serve type frozen confection.
